(19) United States
(12) Patent Application Publication
(10) Pub. No.: US 2019/0346143 A1
(43) Pub. Date: Nov. 14, 2019

(54) INTELLIGENT TERMINAL CONTROL SIMULATED FLAME GENERATOR

(71) Applicant: Dong Guan Song Wei Electric Technology Co., Ltd., Dongguan (CN)

(72) Inventor: Weilin Lu, Dongguan (CN)

(21) Appl. No.: 15/974,686

(22) Filed: May 8, 2018

(51) Int. Cl. F24B 1/18; F21S 10/04

(52) U.S. Cl. CPC F24B 1/1808; F21S 10/046; F21S 10/043

(57) ABSTRACT

An intelligent terminal control simulated flame generator is disclosed. A circuit control device is provided on the basis of a traditional simulated flame generator. All adjustable mechanisms of various light sources, motors and the like are connected with the circuit control device, so that the circuit control device serves as the core of communication and control to achieve wireless communication with an intelligent terminal After the simulated flame generator is actuated, the user not only feels the temperature but also hears the sound of burning firewood and sees the change of the flame, providing a real feeling.

### BACKGROUND OF THE INVENTION

### 1. Field of the Invention

The present invention relates to a simulated flame generator, and more particularly to an intelligent terminal control simulated flame generator.

### 2. Description of the Prior Art

An electric fireplace functions as a household electric appliance, having the advantages of being clean, sanitary, safe and reliable, easy assembly and disassembly, high heating efficiency. Compared with wood burning fireplaces and gas fireplaces, electric fireplaces don't have ashes, strange smell and noises generated when the flame burns. Electric fireplaces not only save heating costs but also bring elegant viewing effect. When in use, electric fireplaces are safe and convenient to bring warm and comfort. Therefore, electric fireplaces are widely used in the modern society, instead of traditional fireplaces.

An improved electric fireplace has a simulated flame effect, but the user cannot hear the cracking sound of burning firewood. Some electric fireplaces play music instead of the sound of burning firewood. Even rare electric fireplaces simulate the sound of burning firewood, the sound is not synchronized with the burning flame, without a realistic feeling. Accordingly, the inventor of the present invention has devoted himself based on his many years of practical experiences to solve these problems.

### SUMMARY OF THE INVENTION

In order to overcome the shortcomings of the prior art, the primary object of the present invention is to provide an intelligent terminal control simulated flame generator that can simulate the cracking sound of burning firewood. The cracking sound of burning firewood changes with the speed or color of the flame is extremely realistic.

In order to achieve the aforesaid object, the present invention adopts the following technical solution.

An intelligent terminal control simulated flame generator comprises a simulated flame generator and an intelligent terminal. The simulated flame generator has a housing. A simulated fuel device is provided at a front of an internal space of the housing. An incandescent light source device which enables a simulated fuel to generate incandescent light is provided under the simulated fuel device. A flare light source device is provided behind the simulated fuel device. A flare generator is provided above the flare light source device. A light shading device is provided in front of the flare generator. A flame imaging device is provided between a rear of the simulated fuel device and the light shading device.

A sound generator is provided on a top of a front of the housing. A circuit control device is provided inside the housing. The sound generator, the incandescent light source device, the flare light source device and the flare generator are electrically connected to the circuit control device.

The circuit control device is provided with a single-chip microcomputer, a peripheral control circuit, a wireless control module, and a sound control circuit. The sound control circuit is connected to the peripheral control circuit. The wireless control module is connected to the single-chip microcomputer for wireless communication with the intelligent terminal.

The single-chip microcomputer has a built-in memory chip. The built-in memory chip stores the sound of burning real firewood when a simulated flame is generated. The sound of burning firewood changes with the speed or color of the flame to show a waveform signal of a different frequency of the sound. The waveform signal is sent to an APP interface of the intelligent terminal through the wireless control module. Through the operation of the APP interface, the sound of burning firewood changes with the speed or color of the flame to change a different cracking sound.

Compared with the prior art, the present invention has obvious advantages and beneficial effects. Specifically, it can be seen from the above technical solution that the sound generator and the circuit control device are added on the basis of the conventional simulated flame generator. The incandescent light source device, the flare light source device, the flare generator, the operation device, the sound generator and the highlighting device are electrically connected to the circuit control device. The circuit control device serves as the core. The simulated flame generator is controlled by the operation device or the intelligent terminal, and is set with a variety of modes, from a soft flame to an intense flame, according to the need. The circuit control device is provided with the single-chip microcomputer, the peripheral control circuit, the wireless control module, and the sound control circuit. The single-chip microcomputer has the built-in memory chip. The built-in memory chip stores the sound of burning real firewood when a simulated flame is generated. The sound of burning firewood changes with the speed or color of the flame to show a waveform signal of a different frequency of the sound. The waveform signal is sent to the APP interface of the intelligent terminal through the wireless control module. Through the operation of the APP interface, the sound of burning firewood changes with the speed or color of the flame to change a different cracking sound. The flame simulation effect is very realistic. In addition to feel the temperature, the user can see the change of the flame and hear the sound of burning firewood, giving a true feeling.

### BRIEF DESCRIPTION OF THE DRAWINGS

FIG. 1 is a block diagram in accordance with an embodiment of the present invention;

FIG. 2 is a structural circuit control schematic view in accordance with an embodiment of the present invention;

FIG. 3 is a block diagram of a simulated flame generator according to an embodiment of the present invention;

FIG. 4 is a waveform diagram of a sound control according to an embodiment of the present invention; and

FIG. 5 is a schematic view of an APP interface of an intelligent terminal device according to an embodiment of the present invention.

### DETAILED DESCRIPTION OF THE PREFERRED EMBODIMENTS

Embodiments of the present invention will now be described, by way of example only, with reference to the accompanying drawings.

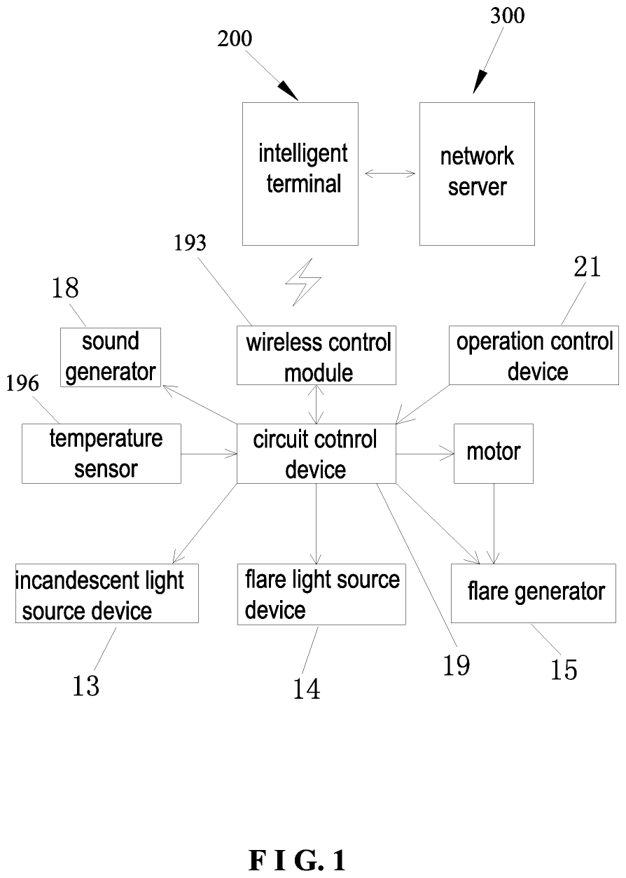

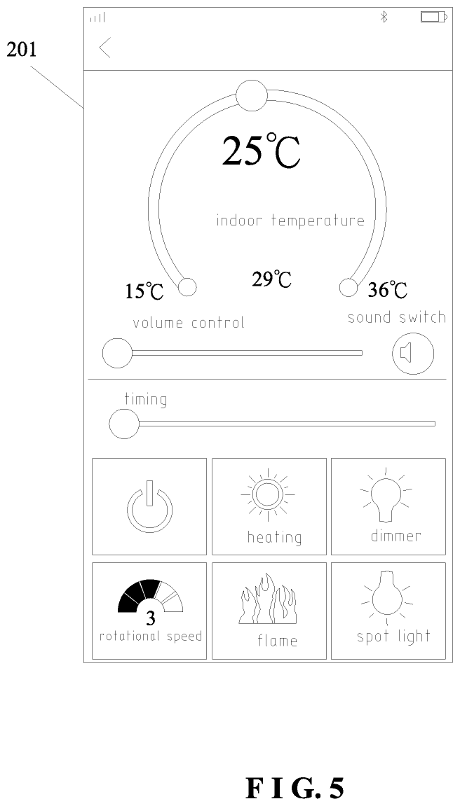

Referring to FIG. 1 and FIG. 5, the specific structure of the preferred embodiment of the present invention is shown. The intelligent terminal control simulated flame generator comprises a simulated flame generator 100 and an intelligent terminal 200. The intelligent terminal 200 may be an intelligent mobile phone, a tablet computer, or other intelligent devices that can be operated by apps. The simulated flame generator 100 and the intelligent terminal 200 realize wireless communication therebetween and send control signals through the wireless communication technology. In addition, the intelligent terminal 200 may further communicate with a network server/cloud server 300 to better understand the user's habits and facilitate communication with the user.

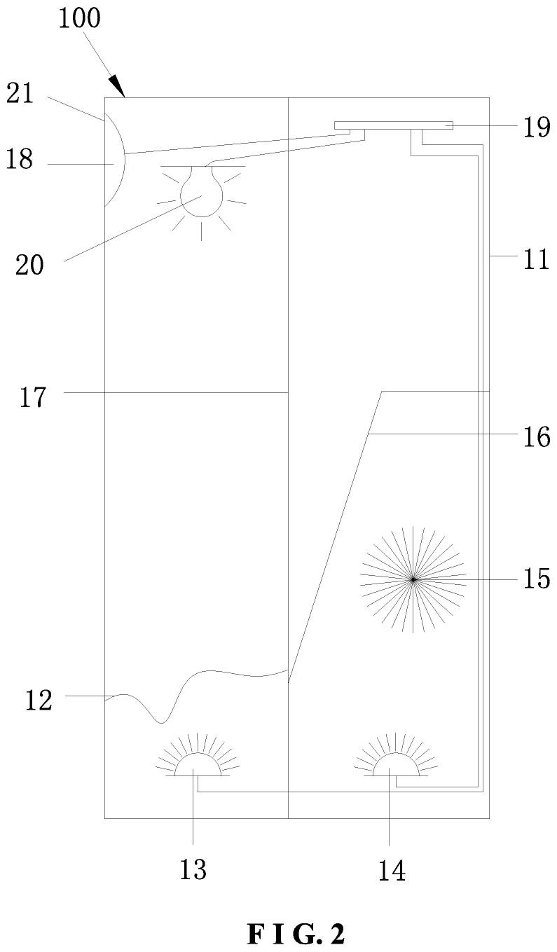

As shown in FIG. 2, the simulated flame generator 100 has a housing 11. The front of the internal space of the housing 11 is provided with a simulated fuel device 12. An incandescent light source device 13 which enables the simulated fuel to generate incandescent light is provided under the simulated fuel device 12. A flare light source device 14 is provided behind the simulated fuel device 12. A flare generator 15 is provided above the flare light source device 14. A light shading device 16 is provided in front of the flare generator 15. A flame imaging device 17 is provided between the rear of the simulated fuel device 12 and the light shading device 16.

In operation, the shape of the simulated fuel device 12 is made into the shape of charcoal or firewood. The incandescent light source device 13 generates light and heat inside the simulated fuel device 12 to simulate the scene of burning firewood, meanwhile, the flare light source device 14 at the rear is turned on. The motor drives the flare generator 15 to rotate so as to reflect the light to the light shading device 16, so that the light is shot through the light shading device 16 to the flame imaging device 17 so as to simulate the flaming state. The invention also makes the following design on the sound emitted by the firewood when the fire is burning.

As shown in FIG. 2, a sound generator 18 is provided on the top of the front of the housing 11. A circuit control device 19 is provided inside the housing 11. The sound generator 18, the incandescent light source device 13, the flare light source device 14 and the flare generator 15 are electrically connected to the circuit control device 19. Therefore, the circuit control device 19 serves as a core to control the volume of the sound of burning firewood, control the brightness and heat regulation of the incandescent light source device 13, control the brightness/darkness change of the flare light source device 14, and control the brightness/darkness change of the built-in light source of the flare generator 15 and the rotational speed of the motor.

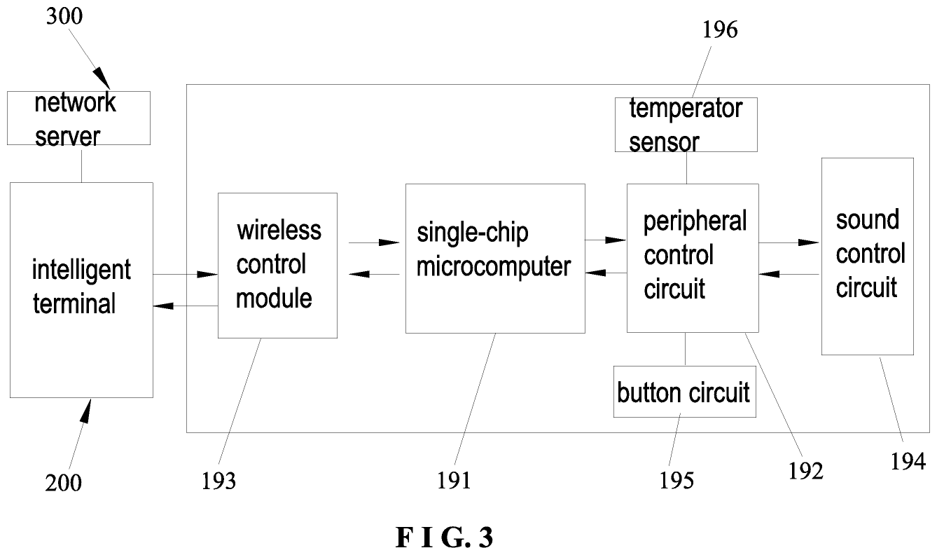

Specifically, as shown in FIG. 3 to FIG. 5, the circuit control device 19 is provided with a single-chip microcomputer 191, a peripheral control circuit 192, a wireless control module 193, and a sound control circuit 194. The sound control circuit 194 is connected to the peripheral control circuit 192 of the single-chip microcomputer 191. The wireless control module 193 is connected to the single-chip microcomputer 191 for wireless communication with the intelligent terminal 200. Wherein, the single-chip microcomputer 191 has a built-in memory chip. The built-in memory chip stores the sound of burning real firewood when a simulated flame is generated. The sound of burning firewood may be changed with the speed or color of the flame to show a waveform signal of a different frequency of the sound. The waveform signal is sent to an APP interface 201 of the intelligent terminal 200 through the wireless control module 193. Through the operation of the APP interface 201, the sound of burning firewood can be changed with the speed or color of the flame to change a different cracking sound.

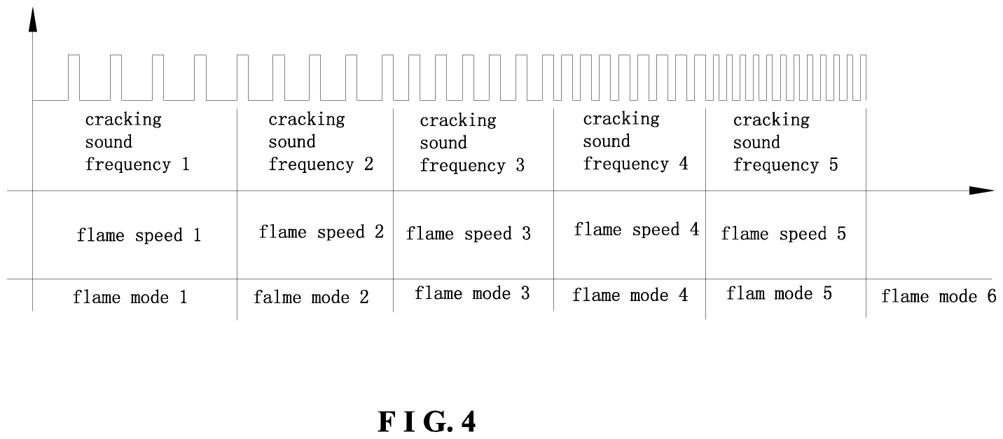

For example, as shown in FIG. 4, the flame burning has different modes, for example, five modes. Each mode is composed of a cracking sound frequency, a flare light source brightness/darkness, a flare light source brightness/darkness and the degree of heat, a rotational speed of the motor of the flare generator. In this embodiment, the first mode may be set as: a low frequency cracking sound, a slow soft flame, a dark simulated fuel, and a slow rotational speed of the motor. In this way, from the first mode to the second mode until the fifth mode, the intensity is increasing in order. When the fifth mode is selected, the cracking sound frequency is high, the flame speed is the highest, and the burning of the simulated fuel is more intense. Since these modes are stored in the built-in memory chip of the single-chip microcomputer 191. The sound can still be played continuously even after the APP interface 201 is turned off.

In addition, a highlighting device 20 is provided above the simulated fuel device 12. The highlighting device 20 is interconnected with the circuit control device 19. When a different burning mode is selected, the brightness of the highlighting device 20 is switched accordingly. For example, when the burning is softer, the highlighting device 20 is not bright or slightly bright. When the burning is the most intense, the highlighting device 20 is the brightest, making the interior of the simulated flame generator 100 more red.

Furthermore, the circuit control device 19 is provided with a button circuit 195. The button circuit 195 is connected to the peripheral control circuit 192 of the single-chip microcomputer 191. An operation control device 21 is provided on the top of the front of the housing 11 and is connected to the button circuit 195. The operation control device 21 is manually operated to control the simulated flame generator 100.

Furthermore, the circuit control device 19 is provided with a temperature sensor 196. The temperature sensor 196 is connected to the peripheral control circuit 192 of the single-chip microcomputer 191. The temperature sensor 196 monitors the temperature of the indoor environment in real time. The temperature is uploaded to the intelligent terminal 200 through the wireless control module 193 and displayed on the APP interface 201, so that the temperature of the indoor environment can be quickly changed by the mobile phone.

The operation of the intelligent terminal control simulated flame generator of the present invention is described below. The circuit control device 19 stores different rotational speeds of the motor and different simulated fuel modes corresponding to different simulated cracking sound frequencies. When a different rotational speed of the motor is adjusted on the APP interface 201, the system automatically adapts the corresponding simulated cracking sound frequency and the corresponding simulated fuel mode to synchronously adjust the incandescent light source device 13, the flare light source device 14, the flare generator 15 and the sound generator 18, so that each device is running in the corresponding mode. In the meantime, the temperature sensor 196 monitors the ambient temperature in real time and uploads the temperature data to the APP interface 201, so that the user can intuitively and conveniently view the temperature change. In addition, the sound generator 18 of the simulated flame generator may be used as a normal speaker to open the APP interface 201. The selection of music is provided on the APP interface 201. The selected music data is sent to the circuit control device 19 of the simulated flame generator. The music is played through a music player and a speaker, allowing the user to enjoy soft music.

Another use condition is that the cracking sound of burning firewood can only be controlled through the APP interface 201 of the intelligent remote control terminal and cannot be controlled directly on the simulated flame generator 100. Through the APP interface 201, the cracking sound of burning firewood can be selectively turned on or off, and the volume of the cracking sound of burning firewood can be controlled separately.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An intelligent terminal control simulated flame generator, comprising a simulated flame generator and an intelligent terminal, the simulated flame generator having a housing, a simulated fuel device being provided at a front of an internal space of the housing, an incandescent light source device which enables a simulated fuel to generate incandescent light being provided under the simulated fuel device, a flare light source device being provided behind the simulated fuel device, a flare generator being provided above the flare light source device, a light shading device being provided in front of the flare generator, a flame imaging device being provided between a rear of the simulated fuel device and the light shading device, characterized by:
a sound generator being provided on a top of a front of the housing, a circuit control device being provided inside the housing, the sound generator, the incandescent light source device, the flare light source device and the flare generator being electrically connected to the circuit control device;
the circuit control device being provided with a single-chip microcomputer, a peripheral control circuit, a wireless control module and a sound control circuit, the sound control circuit being connected to the peripheral control circuit, the wireless control module being connected to the single-chip microcomputer for wireless communication with the intelligent terminal;
the single-chip microcomputer having a built-in memory chip, the built-in memory chip storing the sound of burning real firewood when a simulated flame is generated, the sound of burning firewood changing with the speed or color of the flame to show a waveform signal of a different frequency of the sound, the waveform signal being sent to an APP interface of the intelligent terminal through the wireless control module, through the operation of the APP interface, the sound of burning firewood changing with the speed or color of the flame to change a different cracking sound.

2. The intelligent terminal control simulated flame generator as claimed in claim 1, wherein a highlighting device is provided above the simulated fuel device, and the highlighting device is interconnected with the circuit control device.

3. The intelligent terminal control simulated flame generator as claimed in claim 1, wherein the circuit control device is provided with a button circuit, the button circuit is connected to the peripheral control circuit, an operation control device is provided on the top of the front of the housing and is connected to the button circuit, and the operation control device is manually operated to control the simulated flame generator.

4. The intelligent terminal control simulated flame generator as claimed in claim 1, wherein the circuit control device is provided with a temperature sensor, the temperature sensor is connected to the peripheral control circuit, the temperature sensor monitors the temperature of an indoor environment in real time, and the temperature is uploaded to the intelligent terminal through the wireless control module and displayed on the APP interface.

5. The intelligent terminal control simulated flame generator as claimed in claim 1, wherein the intelligent terminal communicates with a cloud server.

6. The intelligent terminal control simulated flame generator as claimed in claim 5, wherein the intelligent terminal is an intelligent mobile phone.
